(19) United States
(12) Patent Application Publication
(10) Pub. No.: US 2026/0158544 A1
(43) Pub. Date: Jun. 11, 2026

(54) LASER CUTTING METAL BATTERY COMPONENTS FOR BATTERY MANUFACTURE

(71) Applicant: Wirtz Manufacturing Company, Inc., Port Huron, MI (US)

(72) Inventors: Michael R. Romeo, St. Clair, MI (US); Jason P. Miller, St. Clair, MI (US)

(21) Appl. No.: 19/410,130

(22) Filed: Dec. 5, 2025

Related U.S. Application Data
(60) Provisional application No. 63/728,219, filed on Dec. 5, 2024.

(51) Int. Cl. B22D 11/126; B22D 11/06; B23K 26/38; B23K 101/36; B23K 103/08; H01M 4/04; H01M 4/73

(52) U.S. Cl. CPC B22D 11/1265; B22D 11/0602; B23K 26/38; H01M 4/0433; H01M 4/73; B23K 2101/36; B23K 2103/08

(57) ABSTRACT

A metal battery component manufacture assembly and method of making metal battery components for battery manufacture are set forth. The assembly and method involve employment of a laser assembly. The laser assembly serves to furnish a non-contact severing and cutting operation to a continuous strip of metal battery components such as a continuous strip of metal battery grids or a continuous strip of metal bipolar battery foils. Unwanted sprues are removed more readily from the continuous strip of metal battery components via the laser assembly and the associated non-contact severing and cutting operation. The sprues are the result of a continuous casting process carried out to form the continuous strip of metal battery components.

### CROSS-REFERENCE TO RELATED APPLICATION

This application claims the benefit of U.S. Provisional Patent Application No. 63/728,219, with a filing date of Dec. 5, 2024, the contents of which are hereby incorporated by reference in their entirety.

### TECHNICAL FIELD

This disclosure relates generally to battery component manufacturing equipment and processes and, more particularly to, equipment and processes employed to continuously cast battery components such as battery grids and battery foils.

### BACKGROUND

Batteries are a common source of electrical energy and are often used as automotive batteries, marine batteries, consumer equipment batteries, small engine batteries, industrial batteries, as well as in other mobile and stationary applications. Different types of batteries have different components. Certain types of lead-acid batteries, for instance, include numerous positive and negative plates that are made of metal grids (typically lead-based) and assembled in a case, with an electrochemically-active battery paste material applied on the grids. The grids serve as the current conductor or current collector of the established electrode, and the paste material serves as the active electrochemical material of the electrode.

Making lead-based grids remains an important part in the manufacture of commercially suitable lead-acid batteries. It often involves considerable metallurgic microstructure control to impart satisfactory mechanical strength, corrosion resistance, creep resistance, paste adhesion, as well as other sought-after properties. For commercial and mass production of battery plates, the grids can be produced via a continuous production procedure and can then be subjected to a paste application procedure, among other procedures that can be carried out. Examples of a continuous casting machine for continuous production is described in U.S. Pat. No. 10,981,218, assigned to Wirtz Manufacturing Company, Inc., the present applicant, and is described in U.S. Pat. No. 12,138,681, assigned to the present applicant. And an example of a pasting machine is described in U.S. Pat. No. 4,606,383, assigned to the present applicant.

Batteries with bipolar architectures, as another example, are chemistry agnostic but most are of the lead-acid type. Bipolar batteries typically have individual electrochemical cell compartments that are isolated by current collectors. Each current collector, also called a bipole, has positive electrochemically active material at one side and has negative electrochemically active material at an opposite side. Bipoles can take the form of a thin foil composed of a lead-based alloy metal. Still, efficient commercial production of thin foil bipoles remains an industry challenge.

### SUMMARY

In an embodiment, a method of making metal battery components for battery manufacture is set forth. The method may involve continuously casting a continuous strip of metal battery components via a belt caster wheel assembly. The continuous strip of metal battery components has a multitude of sprues upon its egress from the belt caster wheel assembly. The method may further involve emitting a laser beam to the continuous strip of metal battery components at a location and position that is downstream of the belt caster wheel assembly. The laser beam severs the multitude of sprues from the continuous strip of metal battery components.

In an embodiment, a metal battery component manufacture assembly for batteries may include a belt caster wheel assembly and a laser assembly, among other possible assemblies and components. The belt caster wheel assembly serves to produce a continuous strip of metal battery components. The belt caster wheel assembly may include a caster wheel, a moveable belt, and one or more shoes. The continuous strip of metal battery components has a multitude of sprues. The laser assembly is situated downstream of the belt caster wheel assembly. The laser assembly emits a laser beam to the continuous strip of metal battery components. The laser beam serving to sever the multitude of sprues from the continuous strip of metal battery components.

In an embodiment, a method of making metal battery components for battery manufacture is set forth. The method may involve continuously casting a continuous strip of metal battery components via a belt caster wheel assembly. The continuous strip of metal battery components has a multitude of sprues upon its egress from the belt caster wheel assembly. The method may further involve emitting a laser beam to the continuous strip of metal battery components at a location and position that is downstream of the belt caster wheel assembly. The laser beam emittance is at and along a separation line that resides near the multitude of sprues. The laser beam severs the multitude of sprues from the continuous strip of metal battery components. A severed edge of the continuous strip of metal battery components—a consequence of the laser beam severing—constitutes an outer boundary of the continuous strip of metal battery components. Furthermore, emitting the laser beam and severing the multitude of sprues involves emitting the laser beam and severing the multitude of sprues while the continuous strip of metal battery components is in the midst of moving downstream of the belt caster wheel assembly and without cessation of movement of the continuous strip of metal battery components.

Further scope of applicability of the present disclosure will become apparent from the detailed description provided hereinafter. But it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given below and the accompanying drawings, which are given by way of illustration only, and do not limit the present disclosure, and wherein:

FIG. 1 is a schematic block diagram of an embodiment of a metal battery component manufacture assembly for batteries, the assembly equipped with a laser assembly;

FIG. 2 is a perspective view of an embodiment of the metal battery component manufacture assembly for batteries, the assembly equipped with the laser assembly;

FIG. 3 is a top view of the metal battery component manufacture assembly of FIG. 2;

FIG. 4 shows an embodiment of a mold cavity;

FIG. 5 is an embodiment of a solidified continuous strip of metal battery grids having a multitude of sprues;

FIG. 6 shows the solidified continuous strip of metal battery grids of FIG. 5 with the multitude of sprues removed; and

FIG. 7 is an embodiment of a solidified continuous strip of metal bipolar battery foils.

### DETAILED DESCRIPTION

With reference to the figures, an embodiment of a metal battery component manufacture assembly 10 equipped with a laser assembly 12—as well as a method involving same—is shown and described herein. The laser assembly 12 serves to furnish a non-contact severing and cutting operation to a continuous strip of metal battery components such as grids 14. A multitude of sprues 16 are removed more readily from the continuous strip of metal battery grids 14 via the laser assembly 12 and the associated non-contact severing and cutting operation. In the past, sprues were commonly sheared off with an in-line slitter having a blade that made physical contact with the grids. This typically occurred after reeling, de-reeling, and material take-off (MTO) and before pasting amid the larger lead-acid battery component production line. Still, in other cases, sprues were sheared off with a rotary plate cutter that again had a blade that made physical contact with the grids. This typically occurred later, after pasting. While effective, these past approaches were not without challenges, and not as efficient and effective as often sought in commercial and mass production operations associated with lead-acid battery component manufacture.

One challenge encountered in the past was the precision tolerances demanded for accurate shearing and resulting grid heights. Grid tracking had to remain within a tight tolerance of one thousandth of an inch (0.001 inches) to five thousandths of an inch (0.005 inches) for shearing in order to ensure necessary grid heights for downstream joining via cast-on-strap (COS) processing that is widely employed in lead-acid battery manufacture. Imprecise grid heights have been shown to hinder proper COS processing. Once grids are cast and coiled, their position and orientation in space is effectively lost. Regaining the grid tracking for shearing purposes could be difficult, or at least not as easily facilitated as when maintained in the first place. Moreover, while shearing immediately after casting and before coiling was perhaps ideal to maintain tracking and tolerances, shearing with blades was found to be impractical due to the excessive perturbations caused by the blade physical contact that precluded the requisite reeling downstream of casting. Another challenge encountered in the past was with components composed of a lead antimony alloy material. Lead antimony alloy grids proved too hard and brittle for effective shearing with blades that made physical contact with the grids. Yet another challenge encountered was with the processing of metal scrap when it is generated in a secondary operation at a location that is remote of—and lacking close proximity to—the casting operation and accompanying melt pot.

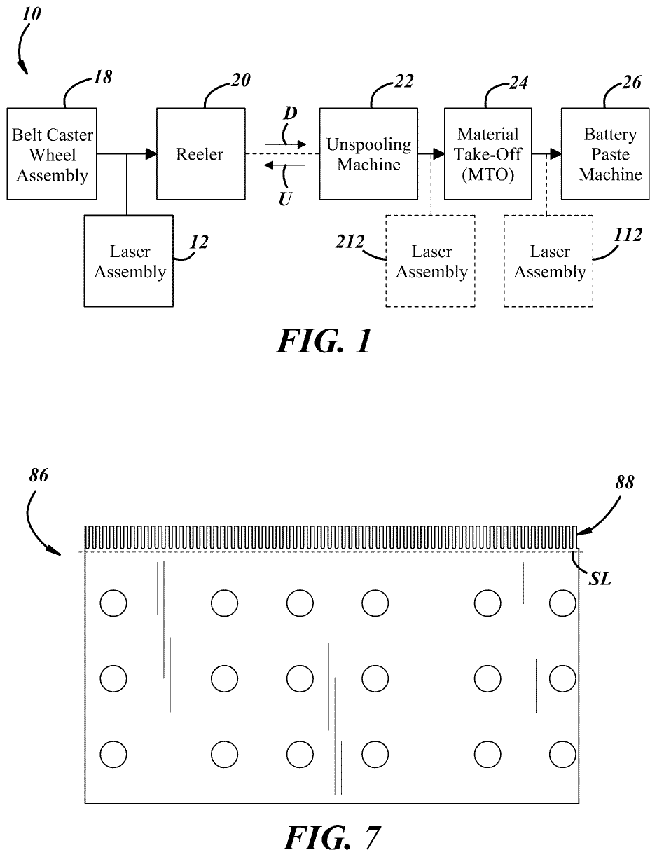

The non-contact severing and cutting operation of the sprues 16 furnished via the laser assembly 12, on the other hand, can be readily incorporated immediately downstream of casting and upstream of reeling, facilitating grid tracking and preservation of precision tolerances for severing and accurate grid heights. Since physical blade contact is foregone with use of the laser assembly 12, suitable reel-to-reel processing in the midst of casting is maintained. Furthermore, grids composed of a lead antimony alloy material are suitable for use and severing and cutting via the laser assembly 12, despite their inherently hard and brittle properties. Yet further, when carried out immediately downstream of casting and upstream of reeling, severed sprue portions (also called off-all or metal scrap) are more readily conveyed and returned to a molten casting pot, or melt pot (introduced below), of the metal battery component manufacture assembly 10 for remelting and further use. Still, a particular embodiment of the metal battery component manufacture assembly 10 and method may exhibit only one, or a combination of, the advancements set forth herein, none of the advancements, or other advancements unmentioned herein. Overall, a more effective and efficient metal battery component manufacture assembly 10 and method are provided, enhancing facilitation of commercial and mass production operations in lead-acid battery component manufacture. Further, the metal battery component manufacture assembly 10 and method can be employed in a larger manufacturing setup and process that produces lead-acid batteries for automotive applications, marine applications, consumer equipment applications, small engine applications, and industrial applications, among many other possibilities. Furthermore, as used herein, the terms upstream and downstream refer to directions with respect to the general and intended aggregate movement and progression of grid processing from casting to subsequent pasting amid their manufacture; in FIG. 1, upstream is generally represented by arrowed line U and downstream is generally represented by arrowed line D.

The metal battery component manufacture assembly 10 and method can include various processes, steps, and machines according to various embodiments. According to the embodiment of FIG. 1, the metal battery component manufacture assembly 10 includes a belt caster wheel assembly 18 and a reeler 20 (also called a reeling machine and operation, and a spooling machine); still, the metal battery component manufacture assembly 10 could include more, less, and/or different machines and steps in other embodiments. Further, the laser assembly 12 is equipped and situated at the location shown in the metal battery component manufacture assembly 10 in FIG. 1 for severing and cutting purposes, as described below. Other machines and operations can be carried out downstream of the belt caster wheel assembly 18 and the reeler 20 according to various embodiments. For example, an unspooling machine 22 can be equipped downstream, as well as a material take-off (MTO) machine 24 and an electrochemically-active battery paste material application machine 26. These other machines and operations can take place at an altogether different site of the larger manufacturing setup and process. The unspooling machine 22 (also called a dereeler) serves to perform an unspooling operation for the continuous strip of metal battery grids 14 in which the grids are unwound and uncoiled for subsequent processing and battery paste application. The MTO machine 24 serves to draw and pull the continuous strip of metal battery grids 14 from the unspooling machine 22 for further processing. Furthermore, the electrochemically-active battery paste material application machine 26 serves to apply electrochemically-active battery paste material to the continuous strip of metal battery grids 14; one example is described in U.S. Pat. No. 9,437,867 issued on Sep. 6, 2016, assigned to Wirtz Manufacturing Company, Inc., the present applicant, and the contents of which are hereby incorporated herein in their entirety by reference.

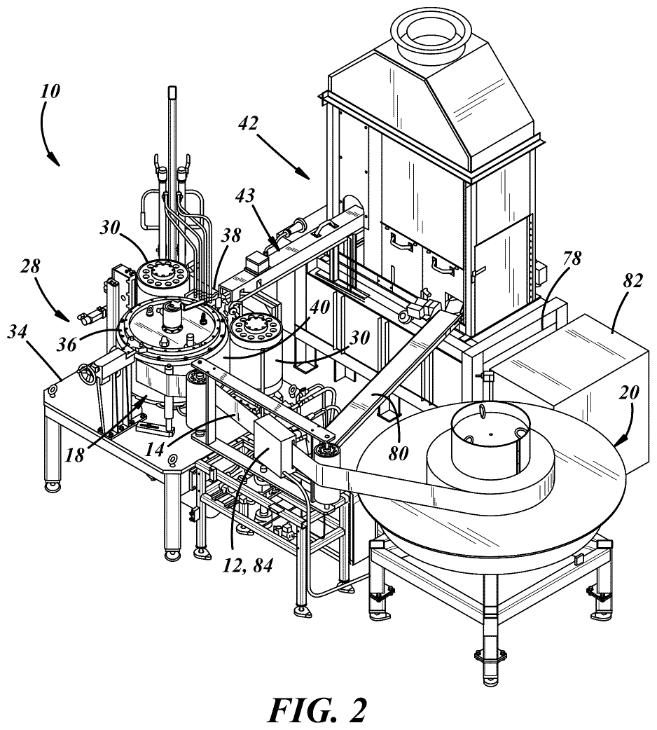

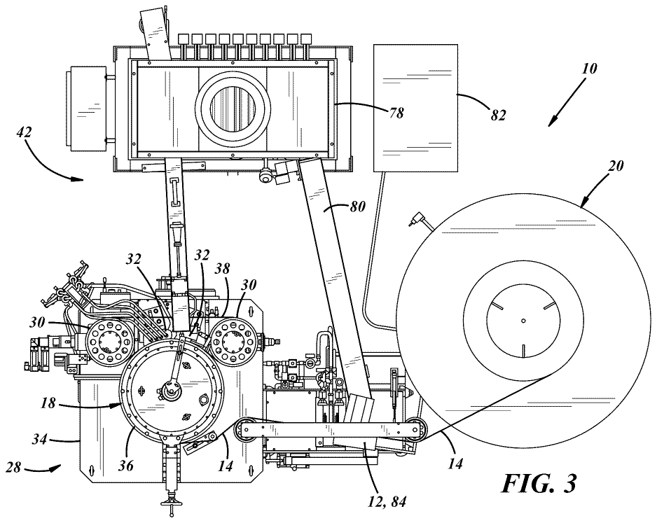

The belt caster wheel assembly 18, according to this embodiment, is part of a larger continuous casting machine 28 that is shown in FIGS. 2 and 3. In general, the continuous casting machine 28 has been shown to produce battery components of metal composition exhibiting a desirably small grain size, relatively uniform grain size, and a crystal morphology throughout the metal structure. It has been determined that these enhanced grain properties are due in part or more to the machine's gravity-fed liquid lead or lead alloy delivery capabilities. The continuous casting machine 28 can have various designs, constructions, and components in various embodiments. In the embodiment of the figures, the continuous casting machine 28 includes—as some of its primary components and assemblies—the belt caster wheel assembly 18, a pair of rollers 30, a pair of temperature-controlled shoes 32, and a frame 34. Still, in other embodiments, the continuous casting machine could have more, less, and/or different primary components and assemblies. Examples of such continuous casting machines are set forth in U.S. Pat. No. 10,981,218 issued on Apr. 20, 2021 and U.S. Pat. No. 12,138,681 issued on Nov. 12, 2024, both assigned to the present applicant, and the contents of both of which are hereby incorporated by reference herein in their entirety.

The belt caster wheel assembly 18 serves to continuously cast the continuous strip of metal battery grids 14 during operation of the continuous casting machine 28. The belt caster wheel assembly 18 is driven to rotate rapidly during operation by a drive motor (unshown) supported beneath a top wall of the frame 34. The drive motor can be of the variable speed electric motor type, or another type, and can have its activation and deactivation and other parameters managed by a system controller such as a programmable logic controller (PLC). A gearbox can be equipped with the drive motor. The belt caster wheel assembly 18 is situated and supported atop the top wall of the frame 34 adjacent the rollers 30 and shoes 32. The belt caster wheel assembly 18 can have various designs, constructions, and components in various embodiments. In the embodiment of FIGS. 2 and 3, the belt caster wheel assembly 18 includes a rotatable caster wheel 36 and a moveable belt 38; still, in other embodiments the belt caster wheel assembly 18 could include more, less, and/or different components.

The rotatable caster wheel 36 is directly driven to rotate during operation by the drive motor. In this embodiment, the rotatable caster wheel 36 has a cylindrical wall at its exterior. At an exterior surface of the cylindrical wall, a mold cavity 40 resides wholly around a circumference thereof. The mold cavity 40 can itself constitute a region or more of the exterior surface of the cylindrical wall. The mold cavity 40 serves to provide a negative space for accepting delivery of the molten lead or lead alloy via a molten lead delivery system 42 during operation of the continuous casting machine 28, and, upon solidification, for ultimate formation of the continuous strip of metal battery grids 14. The molten lead delivery system 42 serves to deliver molten lead or lead alloy to the mold cavity 40 via feed lines 43 and a feed head amid operation of the continuous casting machine 28.

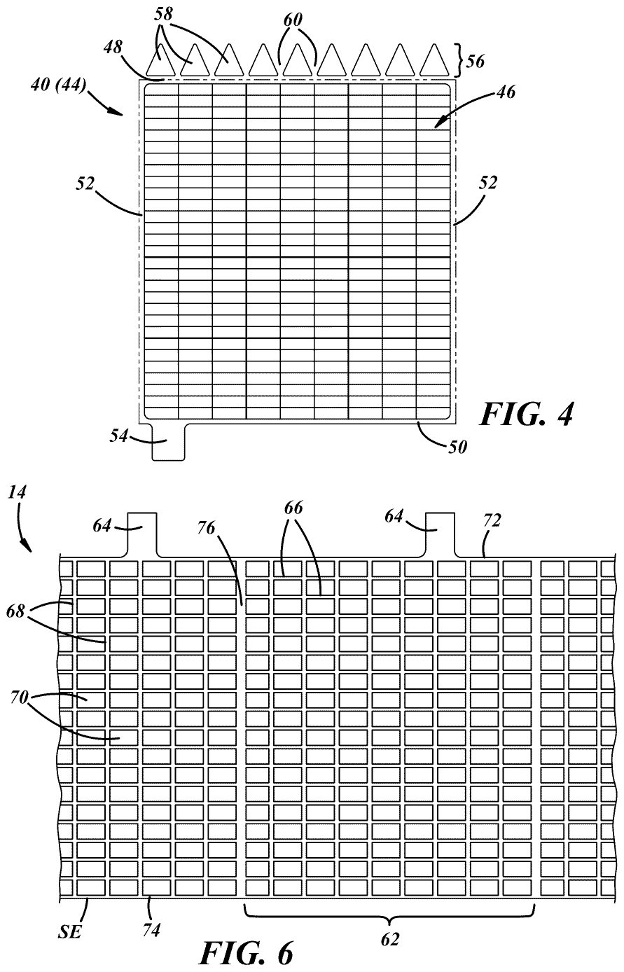

The mold cavity 40 can be a single, uninterrupted mold cavity spanning wholly around the circumference of the cylindrical wall, and can be made-up of multiple individual grid mold cavities situated one-after-another therearound. The mold cavity 40 is engraved in the cylindrical wall. With reference now to FIG. 4, in this embodiment the mold cavity 40 is a grid mold cavity 44. Here, the grid mold cavity 44 has a central grid wire section 46 with numerous horizontally-extending grid wires and vertically-extending grid wires configured in a crisscrossing and intersecting arrangement. Bottom and top frame sections 48, 50 bound upper and lower extents of the central grid wire section 46, and side frame sections 52 bound side extents thereof. Further, each individual metal battery grid produced has a connector lug, and hence the grid mold cavity 44 has an associated lug section 54 for formation thereof.

Furthermore, a gate or runner system 56 is situated adjacent a top end of the rotatable caster wheel 36 and cylindrical wall, and adjacent the mold cavity 40. The runner system 56 spans wholly around the circumference of the rotatable caster wheel 36 and cylindrical wall. The runner system 56 fluidly communicates with the mold cavity 40 and serves to facilitate and ease the supply and delivery of the molten lead or lead alloy to the mold cavity 40. The runner system 56 can have various designs and constructions in various embodiments. In the embodiment of FIG. 4, the runner system 56 has a series of protuberances 58 that establish a series of sprues 60 residing and spanning thereamong. The protuberances 58 are triangular in shape, per this embodiment, providing corresponding triangular-shaped sprues 60. The molten lead or lead alloy flows to the mold cavity 40 via the sprues 60. Still, in other embodiments the runner system 56 could have a series of elongated and axially-directed ribs with channels residing and spanning thereamong for molten lead or lead alloy flow to the mold cavity 40. As an aside, unless otherwise specified in a particular circumstance of usage, the terms axial, radial, and circumferential—as well as their grammatical variations—are used in this description with reference to the generally cylindrical shape of the rotatable caster wheel 36.

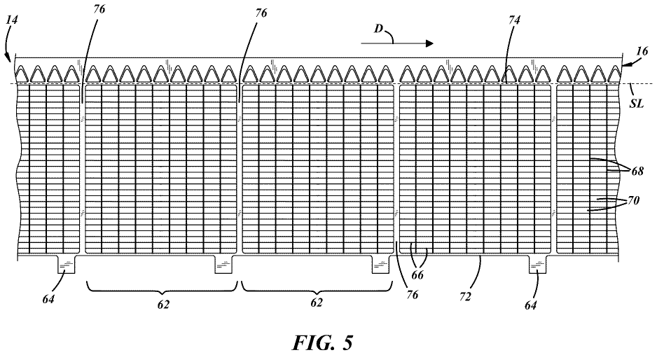

With reference now to FIG. 5, an example of an as-cast continuous strip of metal battery grids 14 or elongated web is depicted. The continuous strip of metal battery grids 14 can be composed of a lead alloy material such as a lead antimony alloy material; example compositions of such lead antimony alloy materials include approximately 0.5 percent (%) to 5.0 % of the total composition, among other possibilities. Further, the continuous strip of metal battery grids 14 can be composed of other materials, including but not limited to, a pure lead material, a lead calcium alloy material, a lead tin alloy material, and/or a lead calcium tin alloy material. The continuous strip of metal battery grids 14 includes multiple individual metal battery grids 62 that are connected together at this stage of processing, but are ultimately severed and separated prior to installation in a lead-acid battery. The grids 62 are typically flat, planar, and thin, and designed and constructed per parameters of the lead-acid battery in which they are installed. The grids 62 can be employed for a positive plate (i.e., cathode) and a negative plate (i.e., anode) of an assembled lead-acid battery. In the example of FIG. 5, the continuous strip of metal battery grids 14 includes connector lugs 64 provided for each grid 62. The continuous strip of metal battery grids 14 and each individual grid 62, per this example, has a multitude of horizontally-extending grid wires 66 and a multitude of vertically-extending grid wires 68 in a crisscrossing and orthogonal arrangement. The grid wires 66, 68 intersect one another at nodes, and open and empty spaces 70 reside among the grid wires 66, 68. A top frame 72 and a bottom or foot frame 74 bound the associated extents of the continuous strip of metal battery grids 14 and each individual grid 62, and side frames 76 bound sides of each grid 62. The top frame 72 and bottom frame 74 constitute outer boundaries of the continuous strip of metal battery grids 14, according to this embodiment. Still, the continuous strip of metal battery grids could have other designs, constructions, and arrangements in other examples; for instance, two sets of continuous strips connected in parallel could be cast concurrently, and/or the grid wires could have other patterns such as an angular zig-zag pattern. Such alternatives will be appreciated by skilled artisans.

Further, when the as-cast continuous strip of metal battery grids 14 immediately exits the continuous casting machine 28 and the belt caster wheel assembly 18, the sprues 16 are provided as a unitary extension of a main body of the as-cast structure of the continuous strip of metal battery grids 14. The sprues 16 are a consequence of the grid casting process at the egress and exit of the continuous casting machine 28 and the belt caster wheel assembly 18, and are hence composed of the same material as the continuous strip of metal battery grids 14, whatever that material may be. In the embodiment of FIG. 5, the sprues 16 exhibit a corresponding design and construction as that of the runner system 56 and its protuberances 58 and sprues 60; in this regard, the sprues 16 are somewhat of a mirror image of the runner system 56. Moreover, the sprues 16 can have various designs and constructions in various embodiments. In FIG. 5, the sprues 16 extend from the bottom frame 74. Before installation in lead-acid batteries, the sprues 16 are severed and removed from the continuous strip of metal battery grids 14. An approximate separation line SL where such severing and cutting operation is intended for execution is shown in FIG. 5 in broken lines. The separation line SL resides and lies immediately adjacent the sprues 16. In this embodiment, the separation line SL possesses and exhibits a parallel arrangement and in-line relationship with a direction of travel and downstream movement D of the continuous strip of metal battery grids 14 as the grids move from the continuous casting machine 28 and the belt caster wheel assembly 18. Once severed and removed, the continuous strip of metal battery grids 14 lacking the sprues 16 resembles the depiction in FIG. 6, according to this embodiment. Moreover, once severed and removed, a severed edge SE constitutes an outer boundary of the continuous strip of metal battery grids 14 which, per this embodiment, is the bottom frame 74. The severed edge SE is established at the separation line SL and via the non-contact severing and cutting operation by the laser assembly 12.

The reeler 20—also called a spooling machine or a coiler—serves to perform a reeling operation of the continuous strip of metal battery grids 14 in which the grids are wound and coiled into a spool for subsequent transport and/or storage purposes after continuous casting and before battery paste application. The reeler 20 can take various forms in various embodiments. With reference again to FIGS. 1-3, in this embodiment the reeler 20 is situated and equipped downstream of the continuous casting machine 28 and the belt caster wheel assembly 18 and upstream of the unspooling machine 22 and electrochemically-active battery paste material application machine 26.

Further, and with reference to FIGS. 2 and 3, in this embodiment the molten lead delivery system 42 is situated upstream of the continuous casting machine 28 and belt caster wheel assembly 18. Among its components, the molten lead delivery system 42 includes a melt pot 78. The melt pot 78 holds the molten lead or lead alloy, and can maintain it in a molten and liquid state prior to its delivery to the rotatable caster wheel 36. Furthermore, and with specific reference to FIG. 3, a conveyor 80 can be provided as part of the metal battery component manufacture assembly 10. The conveyor 80 serves to convey and transport separated and severed sprue portions back to the melt pot 78 for reuse. Since the severed sprue portions are generated in close proximity to the melt pot 78, as demonstrated in the embodiment of FIGS. 2 and 3, this conveyance and transport is more readily facilitated in the metal battery grid manufacture assembly 10. The conveyor 80 can take various forms in various embodiments. In the embodiment of FIG. 3, the conveyor 80 is situated downstream of the continuous casting machine 28 and belt caster wheel assembly 18, and is located adjacent and at the laser assembly 12 in order to collect and receive the sprue portions once and as they are severed and separated. The conveyor 80 can have a location that is beneath the laser assembly 12 in order to catch the separated sprues portions, as an example.

The laser assembly 12 serves to sever and remove the unwanted sprues 16 from the continuous strip of metal battery grids 14. Unlike the past approaches, the laser assembly 12 furnishes a non-contact severing and cutting operation without blades that facilitates grid tracking immediately downstream of the continuous casting machine 28 and belt caster wheel assembly 18, preserving the requisite precision tolerances for grid height. Perturbations observed in the past approaches do not occur with the use of the laser assembly 12. In various embodiments, the laser assembly 12 can have various arrangements relative to other machines in the metal battery grid manufacture assembly 10, can itself take various forms, and can come in various quantities, among other possibilities.

With continued reference to FIGS. 1-3, the laser assembly 12 in this embodiment is situated immediately downstream of the continuous casting machine 28 and belt caster wheel assembly 18, upstream of the reeler 20, and has an in-line arrangement and configuration with respect thereto. One or more laser beams is emitted from the laser assembly 12 and applied directly to the continuous strip of metal battery grids 14 and directly at and along the separation line SL. More particularly, in this embodiment the laser assembly 12 is located and positioned to emit the laser beam in-between the continuous casting machine 28 and belt caster wheel assembly 18 and the reeler 20. Still, other locations and positions are possible, depending on the operations and machines of a particular metal battery grid manufacture assembly; in this regard, and with reference to FIG. 1, the laser assembly could be located and positioned to emit a laser beam in-between the material take-off 24 and the battery paste machine 26 (denoted with reference numeral 112 in the figure), or the laser assembly could be located and positioned to emit a laser beam in-between the unspooling machine 22 and the material take-off 24 (denoted with reference numeral 212 in the figure).

Furthermore, the laser beam(s) emitted by the laser assembly 12 can be applied while the continuous strip of metal battery grids 14 is in the midst of processing movement in the metal battery component manufacture assembly 10. The laser assembly 12 and its components can remain static relative to the movement of the continuous strip of metal battery grids 14. Movement of the continuous strip of metal battery grids 14 need not cease or otherwise pause for severing and removal purposes via the laser assembly 12. The continuous strip of metal battery grids 14 can continue and maintain its downstream movement and pace from the continuous casting machine 28 and belt caster wheel assembly 18 and to the reeler 20 while the laser assembly 12 is deployed and utilized according to this embodiment. In this way, the laser assembly 12 and its laser beam application and emission can be readily incorporated and integrated into the metal battery component manufacture assembly 10, further enhancing facilitation of commercial and mass production operations in lead-acid battery component manufacture.

The laser assembly 12 can have various forms, kinds, and types in various embodiments. In an example embodiment, the laser assembly 12 can be a fiber laser assembly. The fiber laser assembly can emit one or more pulsed laser beams. The emitted laser beam can be aimed and directed at the separation line SL of the continuous strip of metal battery grids 14, and can provide non-contact severing capabilities. The laser assembly 12 and fiber laser assembly can include a laser power unit 82 and a laser head 84 in which the laser beam is emitted from. The laser head 84 can be mounted and fixtured in place in the metal battery component manufacture assembly 10. Its placement can be above, below, and/or at a side of the continuous strip of metal battery grids 14 as the continuous strip of metal battery grids 14 are moving immediately downstream from the continuous casting machine 28 and belt caster wheel assembly 18, depending on the implementation and installation. It has been determined that in order to more readily ensure the integrity of the structure of the continuous strip of metal battery grids 14 without appreciable or without any changes thereto, a level of power of the emitted laser beam can range from approximately 200 watts (W) to approximately 1200 W; still, other levels of power are possible in other example embodiments. The laser assembly 12 can be supplied by Boss Laser, LLC of Florida, USA (www.bosslaser.com) according to an example application; still, other suppliers of laser technology and equipment are possible.

With reference now to FIG. 7, the metal battery component manufacture assembly 10 and laser assembly 12 are equally applicable for a continuous strip of metal bipolar battery foils 86. In this regard, the phrase “metal battery component” and its grammatical variations are used herein in a broad sense to encompass both metal battery grids and metal bipolar battery foils. The continuous strip of metal bipolar battery foils 86 are subsequently employed as current collectors in bipolar batteries. The continuous strip of metal bipolar battery foils 86 can be produced, as described, with the continuous casting machine 28 and the belt caster wheel assembly 18, with appropriate modifications thereto for yielding the particular design and construction of the continuous strip of metal bipolar battery foils 86. Similar to the continuous strip of metal battery grids 14, when the as-cast continuous strip of metal bipolar battery foils 86 immediately exits the continuous casting machine 28 and the belt caster wheel assembly 18, a multitude of sprues 88 are provided as a unitary extension of a main body of the as-cast structure of the continuous strip of metal bipolar battery foils 86. The sprues 88 are a consequence of the casting process of the continuous strip of metal bipolar battery foils 86. As set forth, the sprues 88 are severed and removed from the continuous strip of metal bipolar battery foils 86 prior to installation in bipolar batteries, and the laser assembly 12 can be utilized to sever and remove the unwanted sprues 88 from the continuous strip of metal bipolar battery foils 86 at an approximate separation line SL.

In general, while a multitude of embodiments have been depicted and described with a multitude of components and steps in each embodiment, in alternative embodiments of the non-contact severing and cutting operation and accompanying method the components and steps of various embodiments could be intermixed, combined, and/or exchanged for one another. In other words, components and/or steps described in connection with a particular embodiment are not necessarily exclusive to that particular embodiment.

As used herein, the terms “general,” “generally,” “approximately,” and “substantially” are intended to account for the inherent degree of variance and imprecision that is often attributed to, and often accompanies, any design and manufacturing process and measurement, including engineering tolerances, and without deviation from the relevant functionality and intended outcome, such that mathematical precision and exactitude is not implied and, in some instances, is not strictly possible. In other instances, the terms “general,” “generally,” “approximately,” and “substantially” are intended to represent the inherent degree of uncertainty that is often attributed to any quantitative comparison, value, and measurement calculation, or other representation, such that mathematical precision and exactitude is not implied and, in some instances, is not strictly possible.

It is to be understood that the foregoing description is not a definition of the invention, but is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” and “such as,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

Those of skill in the art will understand that modifications (additions and/or removals) of various components of the substances, formulations, apparatuses, methods, systems, and embodiments described herein may be made without departing from the full scope and spirit of the present disclosure, which encompass such modifications and any and all equivalents thereof.

1. A method of making metal battery components for battery manufacture, the method comprising:
continuously casting a continuous strip of metal battery components via a belt caster wheel assembly, the continuous strip of metal battery components having a plurality of sprues upon egress of the belt caster wheel assembly; and
emitting a laser beam to the continuous strip of metal battery components downstream of the belt caster wheel assembly, the laser beam severing the plurality of sprues from the continuous strip of metal battery components.

2. The method of making metal battery components for battery manufacture as set forth in claim 1, wherein the continuous strip of metal battery components is composed of a lead antimony alloy material, a pure lead material, a lead calcium alloy material, a lead tin alloy material, or a lead calcium tin alloy material.

3. The method of making metal battery components for battery manufacture as set forth in claim 1, wherein emitting the laser beam and severing the plurality of sprues involves emitting the laser beam upstream of a reeling operation of the continuous strip of metal battery grids.

4. The method of making metal battery components for battery manufacture as set forth in claim 1, further comprising conveying severed sprues to a melt pot upon the occurrence of the laser beam severing.

5. The method of making metal battery components for battery manufacture as set forth in claim 1, wherein emitting the laser beam involves emitting a fiber laser beam to sever the plurality of sprues from the continuous strip of metal battery components.

6. The method of making metal battery components for battery manufacture as set forth in claim 1, wherein emitting the laser beam and severing the plurality of sprues involves emitting the laser beam and severing the plurality of sprues while the continuous strip of metal battery components is in the midst of moving downstream of the belt caster wheel assembly and without cessation of movement of the continuous strip of metal battery components.

7. The method of making metal battery components for battery manufacture as set forth in claim 1, wherein emitting the laser beam involves emitting the laser beam at and along a separation line, the separation line residing adjacent the plurality of sprues and, once severed, a severed edge of the continuous strip of metal battery components constitutes an outer boundary of the continuous strip of metal battery components.

8. The method of making metal battery components for battery manufacture as set forth in claim 7, wherein the separation line exhibits a parallel arrangement with a direction of downstream movement of the continuous strip of metal battery components from the belt caster wheel assembly.

9. The method of making metal battery components for battery manufacture as set forth in claim 1, wherein the continuous strip of metal battery components is a continuous strip of metal battery grids or is a continuous strip of metal bipolar battery foils.

10. A metal battery component manufacture assembly for batteries, the metal battery component manufacture assembly comprising:
a belt caster wheel assembly for producing a continuous strip of metal battery components, said belt caster wheel assembly comprising a caster wheel, a moveable belt, and at least one shoe, said continuous strip of metal battery components having a plurality of sprues; and
a laser assembly situated downstream of said belt caster wheel assembly, said laser assembly emitting a laser beam to said continuous strip of metal battery components, said laser beam severing said plurality of sprues from said continuous strip of metal battery components.

11. The metal battery component manufacture assembly as set forth in claim 10, wherein said plurality of sprues extends from a frame of said continuous strip of metal battery components.

12. The metal battery component manufacture assembly as set forth in claim 10, wherein said laser assembly is a fiber laser assembly.

13. The metal battery component manufacture assembly as set forth in claim 10, wherein said continuous strip of metal battery components is composed of a lead antimony alloy material.

14. The metal battery component manufacture assembly as set forth in claim 10, further comprising a reeler situated downstream of said belt caster wheel assembly, said laser assembly situated upstream of said reeler and emitting said laser beam and severing said plurality of sprues prior to said continuous strip of metal battery components being reeled via said reeler.

15. The metal battery component manufacture assembly as set forth in claim 10, further comprising a conveyor and a melt pot, said conveyor receiving severed sprues adjacent said laser assembly and transporting said severed sprues to said melt pot.

16. The metal battery component manufacture assembly as set forth in claim 10, wherein said continuous strip of metal battery components is a continuous strip of metal battery grids or is a continuous strip of metal bipolar battery foils.

17. A method of making metal battery components for battery manufacture, the method comprising:
continuously casting a continuous strip of metal battery components via a belt caster wheel assembly, the continuous strip of metal battery components having a plurality of sprues upon egress of the belt caster wheel assembly; and
emitting a laser beam to the continuous strip of metal battery components at and along a separation line residing adjacent the plurality of sprues, the laser beam emittance occurring downstream of the belt caster wheel assembly, the laser beam severing the plurality of sprues from the continuous strip of metal battery components, wherein a severed edge of the continuous strip of metal battery components constitutes an outer boundary of the continuous strip of metal battery components, and wherein emitting the laser beam and severing the plurality of sprues involves emitting the laser beam and severing the plurality of sprues while the continuous strip of metal battery components is in the midst of moving downstream of the belt caster wheel assembly and without cessation of movement of the continuous strip of metal battery components.

18. The method of making metal battery components for battery manufacture as set forth in claim 17, wherein the separation line exhibits a parallel arrangement with a direction of downstream movement of the continuous strip of metal battery components from the belt caster wheel assembly.

19. The method of making metal battery components for battery manufacture as set forth in claim 17, further comprising conveying severed sprues to a melt pot upon the occurrence of the laser beam severing.
